(19) United States
(12) Patent Application Publication
(10) Pub. No.: US 2023/0393393 A1
(43) Pub. Date: Dec. 7, 2023

(54) AR PROJECTION ASSEMBLY AND AR DEVICE

(71) Applicant: Goertek Optical Technology Co., Ltd., Weifang, Shandong (CN)

(72) Inventors: Pengbo Chen, Weifang, Shandong (CN); Dean Liu, Weifang, Shandong (CN)

(73) Assignee: Goertek Optical Technology Co., Ltd., Weifang, Shandong (CN)

(21) Appl. No.: 18/278,661

(22) PCT Filed: Nov. 25, 2021
(86) PCT No.: PCT/CN2021/133104

§ 371 Date: Aug. 24, 2023

(30) Foreign Application Priority Data
Feb. 24, 2021 (CN) 202110208417.7

(51) Int. Cl. G02B 27/01

(52) U.S. Cl. CPC G02B 27/0101; G02B 2027/011

(57) ABSTRACT

Disclosed are an AR projection assembly and an AR device, and the AR projection assembly comprises: an image displaying source, the image displaying source including a Micro-LED single-color displaying element and a Micro-LED dual-color displaying element; a light combining element, the light combining element being disposed on light emitting paths of the Micro-LED single-color displaying element and the Micro-LED dual-color displaying element and configured to combine single-color light given off by the Micro-LED single-color displaying element and dual-color light given off by the Micro-LED dual-color displaying element into a full-color image; a lens assembly, the lens assembly including a first lens, a second lens and a third lens which are disposed in sequential proximity to the light combining element on a light emitting path of the light combining element, the first lens and the third lens having a positive focal length, and the second lens having a negative focal length.

### CROSS-REFERENCE TO RELATED APPLICATIONS

This application is a National Stage of International Application No. PCT/CN2021/133104, filed on Nov. 25, 2021, which claims priority to Chinese Patent Application No. 202110208417.7, filed on Feb. 24, 2021, both of which are hereby incorporated by reference in their entireties.

### TECHNICAL FIELD

The present disclosure relates to the field of augmented reality, and in particular to an AR projection assembly and an AR device.

### BACKGROUND

In the prior art, in order to enable the AR device to achieve a better display performance, one way for improvement thereof is to increase the resolution of the display in the AR device; however, the higher the resolution is, the larger the size of the display is, which results in an increased overall size of the AR device.

### SUMMARY

The main objective of the present disclosure is to propose an AR projection assembly, aimed to solve the problem of excessive volume of the AR device in the prior art.

In order to achieve the above objective, the present disclosure proposes an AR projection assembly, comprising: an image displaying source, the image displaying source including a Micro-LED single-color displaying element and a Micro-LED dual-color displaying element; a light combining element, the light combining element being disposed on light emitting paths of the Micro-LED single-color displaying element and the Micro-LED dual-color displaying element and configured to combine single-color light given off by the Micro-LED single-color displaying element and dual-color light given off by the Micro-LED dual-color displaying element into a full-color image; and a lens assembly, the lens assembly including a first lens, a second lens and a third lens which are disposed in sequential proximity to the light combining element on a light emitting path of the light combining element, the first lens and the third lens having a positive focal length, and the second lens having a negative focal length.

Further, a distance between a surface of the first lens facing away from the image displaying source and the image displaying source is 16 mm to 20 mm.

Further, a distance between a surface of the first lens facing away from the image displaying source and an entrance pupil position of the AR projection assembly is 2 mm to 4 mm.

Further, the single-color light given off by the Micro-LED single-color displaying element is one of red light, green light and blue light, and correspondingly, the dual-color light given off by the Micro-LED dual-color displaying element is one of green-blue light, red-blue light, and red-green light.

Further, the light combining element has a semi-reflection and semi-transmission property, and the light combining element reflects the single-color light and transmits the dual-color light, or the light combining element transmits the single-color light and reflects the dual-color light.

Further, the lens assembly comprises the first lens, the second lens, and the third lens sequentially disposed from an optical waveguide element towards the position of the optical element, the first lens and the third lens having a positive focal length, and the second lens having a negative focal length.

Further, the first lens has a focal length of f1, the second lens has a focal length of f2, the third lens has a focal length of f3, and satisfying: 2<f1<15, −10<f2<−1, 2<f3<10;
the first lens has an Abbe number of v1, the second lens has an Abbe number of v2, the third lens has an Abbe number of v3, and satisfying: 25<v1<70, 10<v2<40,
the first lens has a refractive index of n1, the second lens has a refractive index of n2, the third lens has a refractive index of n3, and satisfying: 1.5<n1<1.8, 1.6<n2<1.8, 1.6<n3<1.9.

Further, the first lens, the second lens, and the third lens are of a surface type including any one of a spherical surface, an aspherical surface, and a free-form surface.

Further, when the surface types of the first lens, the second lens, and the third lens are all of the aspherical surface type, satisfying:

$$Z = \frac{{cr}^{2}}{1 + \sqrt{1 - ( 1 + k ) {c}^{2} {r}^{2}}} + {a}_{4} {r}^{4} + {a}_{6} {r}^{6} + {a}_{8} {r}^{8} + {a}_{10} {r}^{10}$$

wherein Z represents a distance between a point on the aspheric surface and the vertex of the aspheric surface in a direction of an optical axis; r represents a distance of the point on the aspheric surface from the optical axis; c represents center curvature of the aspheric surface; k represents conicity; a4, a6, a8, a10 represent aspheric higher-order coefficients.

In order to achieve the above objective, the present disclosure further proposes an AR device, and the AR device comprises the AR projection assembly as described in any of the preceding items, and further comprises: a housing in which the AR projection assembly is provided.

In the technical solution of the present disclosure, by dividing the image displaying source into the Micro-LED LED single-color displaying element and the Micro-LED dual-color displaying element, and disposing the light combining element on the light emitting paths of the Micro-LED LED single-color displaying element and the Micro-LED dual-color displaying element, the single-color light given off by the Micro-LED single-color displaying element and the dual-color light of the Micro-LED dual-color displaying element are combined to form the full-color image. Compared with the existing technology which occupies a large space by setting up three Micro-LED chips in red, green and blue on a Micro-LED substrate, in the present disclosure, by reasonably setting positions of the Micro-LED single-color displaying element and the Micro-LED dual color displaying element as well as the light combining element, the Micro-LED single-color displaying element and Micro-LED dual-color displaying element can occupy less space at the same high resolution, therefore solving the problem that the overall size of the AR projection assembly becomes too large due to the large size of the image displaying source under the requirement of high resolution. Further, by disposing the first lens, the third lens with the positive focal length and the second lens with the negative focal length on the light emitting path of the light combining element, and disposing the first lens, the second lens, the third lens and the light combining element in sequence, the first lens, the second lens, and the third lens can effectively correct aberrations such as field curvature, distortion, dispersion and spherical aberration, improve the resolution of the AR projection assembly, and improve the angular resolution of the user in a certain field of view, thereby improving the user's visual experience.

### BRIEF DESCRIPTION OF THE DRAWINGS

In order to clearly illustrate technical solutions in the embodiments or prior art of the present disclosure, the accompanying drawings to be used in the description of the embodiments or prior art will be briefly described below. Obviously, the drawings described below are only some embodiments of the present disclosure. For those of ordinary skill in the art, other drawings may be obtained according to the structure shown in these drawings without creative labor.

FIG. 1 shows a structural schematic diagram of an embodiment of an AR device of the present disclosure;

FIG. 2 shows a structural schematic diagram of an embodiment of an AR projection assembly of the present disclosure;

FIG. 3 shows a graph of an optical transfer function of an optical system comprising a display image source and a lens assembly of the present disclosure.

The realization of the objective, functional features and advantages of the present disclosure will be further described in conjunction with embodiments with reference to the accompanying drawings.

### DETAILED DESCRIPTION

Technical solutions and advantages of the embodiments of the present disclosure clearer, technical solutions in the embodiments of the present disclosure are described below with reference to the accompanying drawings in the embodiments of the present disclosure. Apparently, the described embodiments are merely some rather than all of the embodiments of the present disclosure. All other embodiments, acquired by those of ordinary skill in the art based on the embodiments of the present disclosure without any creative work, should fall into the protection scope of the present disclosure.

It should be noted that all directional indications (such as up, down, left, right, forward, backward . . . ) in the embodiments of the present disclosure are used only for explaining the relative positional relationship, movement, and the like among the various components in a particular attitude (as shown in the accompanying drawings), and that the directional indications change accordingly if the particular attitude is changed.

In addition, expressions “first” and “second” related in the present disclosure are only used for descriptive purposes and should not be understood as indicating or implying relative importance or implying a number of indicated technical features. Therefore, a feature delimited with “first”, “second” may expressly or implicitly include at least one of those features. In addition, the technical solutions between the various embodiments may be combined with each other, but it must be based on the fact that the person of ordinary skill in the field can realize it, and when the combination of the technical solutions is contradictory or unattainable, it should be considered that the combination of such technical solutions does not exist, and is not within the scope of protection of the claims of the present disclosure.

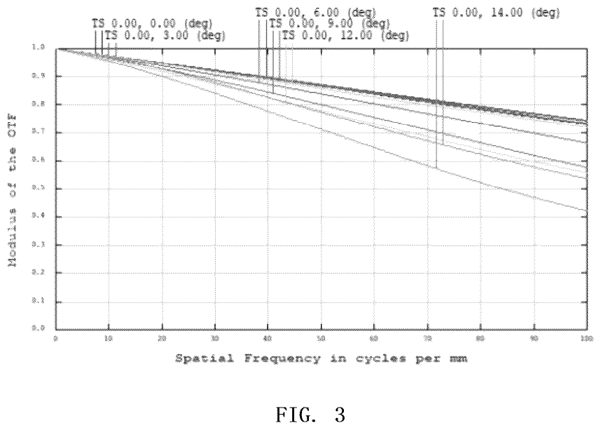

Please refer to FIGS. 1-3, the present disclosure proposes an AR projection assembly 100, comprising: an image displaying source 10, the image displaying source 10 including a Micro-LED single-color displaying element 11 and a Micro-LED dual-color displaying element 12; a light combining element 20, the light combining element 20 being disposed on light emitting paths of the Micro-LED single-color displaying element 11 and the Micro-LED dual-color displaying element 12 and configured to combine single-color light given off by the Micro-LED single-color displaying element 11 and dual-color light given off by the Micro-LED dual-color displaying element 12 into a full-color image; a lens assembly 30, the lens assembly 30 including a first lens 31, a second lens 32 and a third lens 33 which are disposed in sequential proximity to the light combining element 20 on a light emitting path of the light combining element 20, the first lens 31 and the third lens 33 having a positive focal length 33, and the second lens 32 having a negative focal length.

In the present embodiment, the image displaying source 10 is used as a display for displaying images. The image displayed by the image displaying source 10 blends with the real world to form an augmented reality image beyond reality for the human eye 50 to see. The image displaying source 10 includes the Micro-LED single-color displaying element 11 and the Micro-LED dual-color displaying element 12, the Micro-LED single-color displaying element 11 is used for emitting single-color light, for example, the single-color light given off by the Micro-LED single-color displaying element 11 is one of red light, green light and blue light, and correspondingly, the Micro-LED dual-color displaying element 12 is used for emitting dual-color light, for example, the dual-color light given off by the Micro-LED dual-color displaying element 12 is one of green-blue light, red-blue light, and red-green light. The single-color light given off by the Micro-LED single-color displaying element 11 and the dual-color light given off by the Micro-LED dual-color displaying element 12 include three primary colors of light of red light, green light and green light to make the three primary colors of light pass through the light combining element 20 to form a full-color image.

In the present embodiment, the light combining element 20 is disposed on light emitting paths of the Micro-LED single-color displaying element 11 and the Micro-LED dual-color displaying element 12, and is configured to combine the single-color light given off by the Micro-LED single-color displaying element 11 and the dual-color light given off by the Micro-LED dual-color displaying element 12 into the full-color image. Specifically, the light combining element 20 can also be called a filter, has a semi-reflection and semi-transmission property, and may reflect the single-color light and transmit the dual-color light. For example, the single-color light given off by the Micro-LED single-color displaying element 11 is emitted onto the light combining element 20, and the light combining element 20 reflects the single-color light in the direction of the lens assembly 30; the dual-color light given off by the Micro-LED dual-color displaying element 12 is emitted onto the light combining element 20, and the light combining element 20 transmits the dual-color light, such that the dual-color light is also emitted in the direction of the lens assembly 30. At this time, the dual-color light and the single-color light are combined to form the full-color image. Or, the light combining element 20 may transmit the single-color light and reflect the dual-color light. For example, the dual-color light given off by the Micro-LED dual-color displaying element 12 is emitted onto the light combining element 20, and the light combining element 20 reflects the dual-color light in the direction of the lens assembly 30; the single-color light given off by the Micro-LED single-color displaying element 11 is emitted onto the light combining element 20, and the light combining element 20 transmits the single-color light, such that the single-color light is also emitted in the direction of the lens assembly 30. At this time, the single-color light and the dual-color light are combined to form a full-color image. In addition, the light combining element 20 also has a function of correcting aberration. It will be appreciated that the positions of the Micro-LED led single-color displaying element 11 and the Micro-LED dual color displaying element 12 in FIG. 1 may be interchanged.

In the present embodiment, the lens assembly 30 is disposed in the light-emitting direction of the light combining element 20 for correcting aberrations. The lens assembly 30 may be consisted of one or more lenses, and in particular, the lens assembly 30 comprises the first lens 31, the second lens 32, and the third lens 33 which are disposed in sequential proximity to the light combining element 20 in the light-emitting path of the light combining element 20, the first lens 31 and the third lens 33 have a positive focal length 33, the second lens 32 has a negative focal length. More specifically, the first lens 31 has a focal length of f1, the second lens 32 has a focal length of f2, the third lens 33 has a focal length of f3, and satisfying: 2<f1<15, −10<f2<−1, 2<f3<10; the first lens 31 has an Abbe number of v1, the second lens 32 has an Abbe number of v2, the third lens 33 has an Abbe number of v3, and satisfying: 25<v1<70, 10<v2<40, 20<v3<65; the first lens 31 has a refractive index of n1, the second lens 32 has a refractive index of n2, the third lens 33 has a refractive index of n3, and satisfying: 1.5<n1<1.8, 1.6<n2<1.8, 1.6<n3<1.9. In this way, it is possible that the full-color image emitted by the light combining element 20 passes through the first lens 31, second lens 32 and the third lens 33 smoothly without mutation and steepness. Therefore, it is possible to effectively correct aberrations such as field curvature, distortion, dispersion, and spherical aberrations, thereby improving the resolution of the optical system and improving the user's visual experience.

Specifically, specific design parameters for one embodiment of the AR projection assembly 100 are set forth in Table 1 below. Wherein, the surface 51 is a surface of the aperture diaphragm on the optical waveguide element 40 facing the first lens 31, the surface S2 is a surface of the first lens 31 facing the aperture diaphragm, a surface S3 is a surface of the first lens 31 facing the second lens 32, a surface S4 is a surface of the second lens 32 facing the first lens 31, a surface S5 is a surface of the second lens 32 facing the third lens 33, the surface S6 is the surface of the third lens 33 facing the second lens 32, the surface S7 is the surface of the third lens 33 facing the light combining element 20, a surface S8 is a surface of the light combining element 20 facing the Micro-LED single-color displaying element 11, a surface S9 is a surface of the light combining element 20 facing the Micro-LED dual-color displaying element 12, a surface S10 is a surface of the Micro-LED single-color displaying element 11 facing the light combining element 20, and a surface S11 is a surface of the Micro-LED dual-color displaying element 12 facing the light combining element 20.

TABLE 1

| | | | Radius of | | | |
|---|---|---|---|---|---|---|
| | Surface Serial | Surface | Curvature | Thickness | Refractive | Abbe |
| Element | Number | Type | mm | mm | Index Nd | Number Vd |
| Aperture | S1 | | Infinite | 3 | | |
| Diaphragm | | | | | | |
| First Lens | S2 | Aspheric | 110.24 | 3.5 | 1.62 | 52.5 |
| | | Surface | | | | |
| | S3 | Aspheric | −4.249 | 1.5 | | |
| | | Surface | | | | |
| Second Lens | S4 | Aspheric | −4 | 0.8 | 1.65 | 35.3 |
| | | Surface | | | | |
| | S5 | Aspheric | 3.245 | 0.87 | | |
| | | Surface | | | | |
| Third Lens | S6 | Aspheric | 4.323 | 1.9 | 1.73 | 54.5 |
| | | Surface | | | | |
| | S7 | Aspheric | −18.992 | 5 | | |
| | | Surface | | | | |
| Light | S8 | | Infinite | 0.2 | 1.54 | 54.2 |
| Combining | S9 | | Infinite | −4 | | |
| Element | | | | | | |
| single-color | S10 | | — | — | — | — |
| displaying | | | | | | |
| element | | | | | | |
| Dual-color | S11 | | — | — | — | — |
| displaying | | | | | | |
| element | | | | | | |

Further, the AR projection assembly 100 is used in cooperation with the optical waveguide element 40, and the optical waveguide element 40 is disposed on the light emitting path of the lens assembly 30, is spaced from the lens assembly 30, is configured to receive the full-color image emitted by the lens assembly 30, and projects the light of the full-color image into the human eye 50 which light had been transmitted several times and the propagation path of the light has been altered.

In summary, in the present embodiment, by dividing the image displaying source 10 into the Micro-LED LED single-color displaying element 11 and the Micro-LED dual-color displaying element 12, and disposing the light combining element 20 on the light emitting paths of the Micro-LED LED single-color displaying element 11 and the Micro-LED dual-color displaying element 12, the single-color light given off by the Micro-LED single-color displaying element 11 and the dual-color light of the Micro-LED dual-color displaying element 12 are combined to form the full-color image. Compared with the existing technology which occupies a large space by setting up three Micro-LED chips in red, green and blue on a Micro-LED substrate, in the present embodiment, by reasonably setting positions of the Micro-LED single-color displaying element 11 and the Micro-LED dual color displaying element 12 as well as the light combining element 20, the Micro-LED single-color displaying element 11 and Micro-LED dual-color displaying element 12 can occupy less space at the same high resolution, therefore solving the problem that the overall size of the AR projection assembly 100 becomes too large due to the large size of the image displaying source 20 under the requirement of high resolution. Further, by disposing the first lens 31, the third lens 33 with the positive focal length and the second lens 32 with the negative focal length on the light emitting path of the light combining element, and disposing the first lens 31, the second lens 32, the third lens 33 and the light combining element 40 in sequence, the first lens 31, the second lens 32, and the third lens 33 can effectively correct aberrations such as field curvature, distortion, dispersion and spherical aberration, improve the resolution of the AR projection assembly 100, and improve the angular resolution of the user in a certain field of view, thereby improving the user's visual experience.

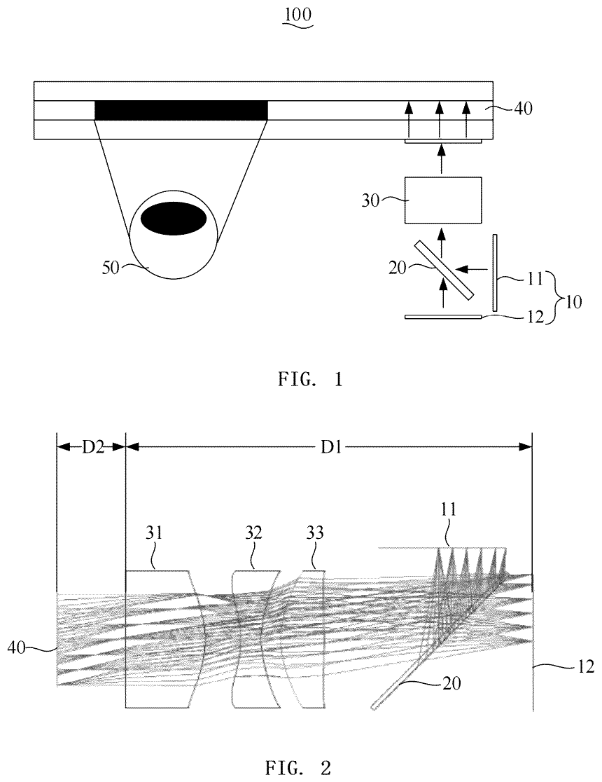

Please refer to FIG. 2, further, a distance D1 between a surface of the first lens 31 facing away from the image displaying source 10 and the image displaying source 10 is 16 mm to 20 mm.

In the present embodiment, the distance D1 between the surface in the lens assembly 30 farthest away from the image displaying source 10 and the image displaying source 10 is 16 mm to 20 mm, and is preferably 18 mm. At this point, the distance between the farthest surface of the image displaying source 10 and the image displaying source 10 is very small. Therefore, the overall size of the image displaying source 10 and the lens assembly 30 can be made very small, while ensuring that the AR projection assembly 100 has a projection image with high-resolution.

Please refer to FIG. 2, further, a distance D2 between a surface of the first lens 31 facing away from the image displaying source 10 and an entrance pupil position of the AR projection assembly 100 is 2 mm to 4 mm.

In the present embodiment, in the lens assembly 30, with regards to the surface of the first lens 31 facing away from the image displaying source 10, that is, the surface of the lens assembly 30 farthest away from the display image source 10, the surface and the entrance pupil position of the AR projection assembly 100 are distanced by a distance D2, that is, there is an entrance pupil distance D2 between the surface and the optical waveguide element 40, D2 may range from 2 mm to 4 mm, preferably 3 mm. In this way, the overall size of the image displaying source 10, the lens assembly 30 and the optical waveguide element 40 can be made very small, while also ensuring that the AR projection assembly 100 has a projection image with high-resolution.

Further, the first lens 31, the second lens 32, and the third lens 33 are of a surface type including any one of a spherical surface, an aspherical surface, and a free-form surface, which is not limited herein in the present embodiment. When the surface types of the first lens 31, the second lens 32, and the third lens 33 are all of the aspherical surface, they satisfy:

$$Z = \frac{{cr}^{2}}{1 + \sqrt{1 - ( 1 + k ) {c}^{2} {r}^{2}}} + {a}_{4} {r}^{4} + {a}_{6} {r}^{6} + {a}_{8} {r}^{8} + {a}_{10} {r}^{10}$$

wherein Z represents a distance between a point on the aspheric surface and the vertex of the aspheric surface in a direction of an optical axis; r represents a distance of the point on the aspheric surface from the optical axis; c represents center curvature of the aspheric surface; k represents conicity; a4, a6, a8, a10 represent aspheric higher-order coefficients.

In the present embodiment, when the surface type of the first lens 31, the second lens 32, and the third lens 33 is the aspherical surface, by adding aspheric higher-order coefficients such as a4, a6, a8, a10, etc. to the above formulas, it is possible to increase the degrees of freedom in the design of the surface type of the aspherical surface of the first lens 31, the second lens 32 and the third lens 33.

In order to achieve the above objective, the present disclosure also proposes an AR device. The AR device comprises the AR projection assembly 100 as described in any of the foregoing, and further comprises a housing (not shown in the figures) in which the AR projection assembly 100 is provided.

In the present embodiment, the AR projection assembly 100 is disposed in the housing, and the housing is further provided with a window for capturing an image of the external real world. After the captured image of the external real world is combined with the image given off by the image displaying source 10, an augmented reality image is formed and enters the human eyes 50. Since the AR device includes the AR projection assembly 100, it has at least the aforementioned advantageous effects of the AR projection assembly 100, which will not be described herein in detail. The AR device may further include the optical waveguide element 40, and the optical waveguide element 40 may be disposed on or in the housing. The optical waveguide element 40 is configured to receive the full-color image emitted by the lens assembly 30, and project the light of the full-color image into the human eye 50 after the light has been transmitted several times and the propagation path of the light has been altered.

The foregoing is only a preferred embodiment of the present disclosure and does not thereby limit the patent scope of the present disclosure. Any equivalent structural transformation made using the description and drawings of the present disclosure under the invention of the present disclosure, or direct/indirect application in other relevant fields of technology, is covered by the patent protection of the present disclosure.

1. An AR projection assembly, comprising:
an image displaying source, including a Micro-LED single-color displaying element and a Micro-LED dual-color displaying element;
a light combining element, disposed on light emitting paths of the Micro-LED single-color displaying element and the Micro-LED dual-color displaying element and configured to combine single-color light given off by the Micro-LED single-color displaying element and dual-color light given off by the Micro-LED dual-color displaying element into a full-color image; and
a lens assembly, including a first lens, a second lens and a third lens which are disposed in sequential proximity to the light combining element on a light emitting path of the light combining element, the first lens and the third lens having a positive focal length, and the second lens having a negative focal length.

2. The AR projection assembly of claim 1, wherein a distance between a surface of the first lens facing away from the image displaying source and the image displaying source is 16 mm to 20 mm.

3. The AR projection assembly of claim 1, wherein a distance between a surface of the first lens facing away from the image displaying source and an entrance pupil position of the AR projection assembly is 2 mm to 4 mm.

4. The AR projection assembly of claim 1, wherein the single-color light given off by the Micro-LED single-color displaying element is one of red light, green light and blue light, and correspondingly, the dual-color light given off by the Micro-LED dual-color displaying element is one of green-blue light, red-blue light, and red-green light.

5. The AR projection assembly of claim 1, wherein the light combining element has a semi-reflection and semi-transmission property, and the light combining element reflects the single-color light and transmits the dual-color light, or the light combining element transmits the single-color light and reflects the dual-color light.

6. The AR projection assembly of claim 1, wherein the first lens has a focal length of f1, the second lens has a focal length of f2, the third lens has a focal length of f3, and satisfying: 2<f1<15, −10<f2<−1, 2<f3<10;
the first lens has an Abbe number of v1, the second lens has an Abbe number of v2, the third lens has an Abbe number of v3, and satisfying: 25<v1<70, 10<v2<40, 20<v3<65; and
the first lens has a refractive index of n1, the second lens has a refractive index of n2, the third lens has a refractive index of n3, and satisfying: 1.5<n1<1.8, 1.6<n2<1.8, 1.6<n3<1.9.

7. The AR projection assembly of claim 6, wherein the first lens, the second lens, and the third lens are of a surface type including any one of a spherical surface, an aspherical surface, and a free-form surface.

8. The AR projection assembly of claim 7, wherein when the surface types of the first lens, the second lens, and the third lens are all of the aspherical surface type, satisfying:
$$Z = \frac{{cr}^{2}}{1 + \sqrt{1 - ( 1 + k ) {c}^{2} {r}^{2}}} + {a}_{4} {r}^{4} + {a}_{6} {r}^{6} + {a}_{8} {r}^{8} + {a}_{10} {r}^{10}$$
wherein Z represents a distance between a point on the aspheric surface and the vertex of the aspheric surface in a direction of an optical axis; r represents a distance of the point on the aspheric surface from the optical axis; c represents center curvature of the aspheric surface; k represents conicity; and a₄, a₆, a₈, a₁₀ represent aspheric higher-order coefficients.

9. An AR device, comprising an AR projection assembly of claim 1, and further comprising:
a housing in which the AR projection assembly is provided.
